(19) United States
(12) Patent Application Publication
(10) Pub. No.: US 2003/0233296 A1
(43) Pub. Date: Dec. 18, 2003

(54) System and method for automated form generation and comparison

(76) Inventor: Brad H. Wagner, Bethesda, MD (US)

Correspondence Address: FLESHNER & KIM, LLP, P. O. Box 221200, Chantilly, VA, 20153-1200, US

(21) Appl. No.: 09/726,613

(22) Filed: Dec. 1, 2000

(51) Int. Cl. G06F 17/60; G06F 17/24; G06F 17/21; G06F 17/00; G06F 15/00

(52) U.S. Cl. 705/31; 707/507

(57) ABSTRACT

A system and method for accessing a remote database and automatically preparing forms based on the accessed data is provided. A form generation engine establishes communication with a remote database, either over a communications network or directly, and retrieves information required to generate a prescribed form. The data is then processed and/or filtered and a form is generated based on the data. Additionally, the form can be electronically filed with a third party requiring the form. Also, the form generation engine can compare data retrieved from the remote database with data inputted by a user to verify accuracy of the user's data. This system is completely platform independent.

### BACKGROUND OF THE INVENTION

1. Field of the Invention The present invention relates to data retrieval and, more particularly, to a method for downloading data and automatically preparing or comparing third party forms.

2. Background of the Related Art

Governmental entities generally require citizens or residents to pay taxes. For example, the federal and state governments of the United States require citizens, non-residents with U.S. filing requirements, corporations, partnerships, trusts, estates, and other entities to file various tax documents on a regular basis. These documents are typically prepared using information supplied by the taxpaying entity who is required to file. The Internal Revenue Service (IRS) maintains a database of the same information that the entity is required to use to file tax forms. The information provided by the taxpaying entity and the taxing authority should theoretically match. In some cases, however, there is a discrepancy between the information.

The IRS provides access to their database materials, so that those with proper authorization can obtain the official IRS data from the IRS database. Specifically, the tax paying entity or its agent, such as an eligible professional having a power of attorney, can access this information by sending a written request to the IRS. The IRS will then provide the requested database information to the tax paying entity or its representative.

Current tax preparation software typically relies only on data entered by the tax preparer to generate tax forms, such as preparation of income tax returns. Accordingly, there is no direct input from the taxation authority. Instead, the user relies on personal data or forms provided by a third party, such as an employer or a bank, to generate tax documents.

Moreover, if the tax preparer or taxpaying entity wishes to verify the tax information with IRS data, they must do so manually. That is, a power of attorney must be filed with the IRS to gain access to the taxpaying entity's tax documents, or a taxpayer may request these documents on the taxpayer's own behalf. Then, a request must be made to the IRS to provide paper copies of tax data from the database. This information must be manually compared to the taxpaying entity's information to determine if there are any discrepancies. In many cases, the information provided by the IRS database does not match the information the taxpaying entity has on hand.

There are many problems with such methods to collect and verify tax data. For example, the current request process is time consuming, and both requires and generates an undue amount of paper work. Additionally, taxpayer forms need to be manually generated and/or compared. Thus, the process of generating and verifying forms is time consuming. Moreover, data provided from the official database needs to be transcribed to taxpayer forms. Hence, the forms could contain transcription errors. Also, in order to verify the accuracy of taxpayer data, taxpayer documents must be manually compared to the IRS's data. This can result in errors, as well as time delays.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of this invention is to provide a method and apparatus for accessing a remote database to download a tax paying entity's personal data.

Another object of this invention is to obtain official government taxpayer information in electronic format to prepare various taxpayer documents, e.g. federal, state, and local income tax returns.

Another object of this invention is to electronically compare taxpayer provided information with official governmental database information using an automated process.

Another object of this invention is to provide a method of automatically accessing a database having information required for completing forms, and automatically preparing the forms using the accessed data.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1a illustrates an automated system for retrieving information from a database.

FIG. 1b illustrates an automated system for retrieving information from an official government database.

FIG. 2a illustrates an automated system for retrieving information from a database over a network.

FIG. 2b illustrates an automated system for retrieving information from an official government database over a network.

FIG. 3 illustrates an embodiment of the form generation engine configured as software modules.

FIG. 4 illustrates another embodiment the form generation engine configured as an apparatus.

FIG. 5 illustrates another embodiment of the automated system for retrieving information from a database over a network including a data arbiter.

FIG. 6 illustrates layers of modular components of the system.

FIG. 7 illustrates a method for acquiring and formatting data.

FIG. 8 illustrates an example of a method of acquiring data from an IRS database.

FIG. 9 illustrates a method of establishing a communications link with a remote database.

FIG. 10 illustrates a method for acquiring data according to another embodiment.

FIG. 11 illustrates a method for acquiring data through a data arbiter.

FIG. 12 illustrates a method of comparing data downloaded from a database.

### DETAILED DESCRIPTION OF PREFERRED EMBODIMENTS

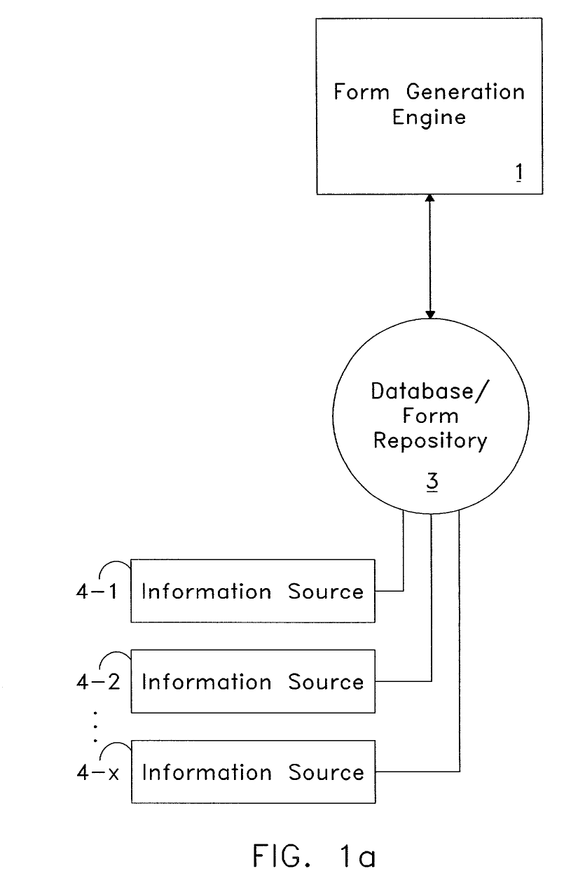

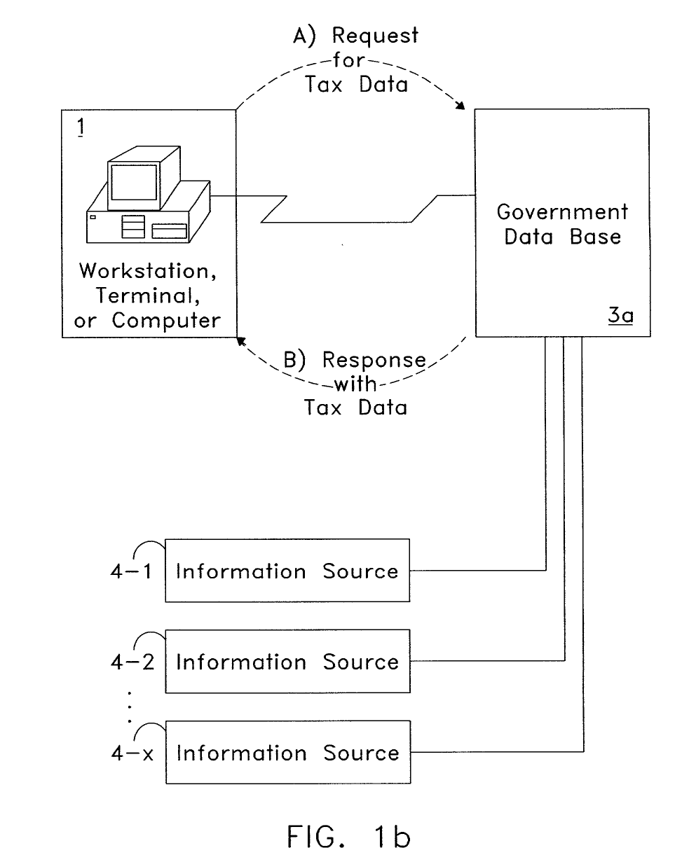

An automated system for retrieving information from a database is depicted in FIG. 1a. The database is preferably a government database as shown in FIG. 1b, but could be any database. For example, it could be a privately owned database or a conglomeration of several databases. Additionally, the database could be a form repository holding information concerning various forms. The information held in the form repository could include the form layout, the information fields required by the form, or the form itself, for example.

As shown in FIG. 1a, a form generation engine 1 is coupled to a database 3. In one embodiment, the form generation engine 1 is software which causes a processor to perform various tasks required to collect various information from the database 3. The processor could be part of a personal computer (PC), a terminal coupled to a network, or an independent input/output device. For example, if the processor is provided as part of an independent input/output device, it the device could be operated by a user to access the database 3, or it could be a remote server, such as an arbiter, which is accessed by a plurality of users for accessing the database and generating forms. Each of these examples of hardware would be controlled by the form generation engine 1. Alternatively, in another embodiment, the form generation engine could itself be a hardware device which retrieves data from the database 3 and generates forms. In such a configuration, the form generation engine 1 could be part of or incorporated into any input/output device, for example a PC, a terminal, or independent input/output device. Additionally, it could be directly operated by a user to access the database 3, or it could be an arbiter which is coupled to the database 3 and allows a plurality of users to access it to retrieve data and generate forms.

The database could be any type of database. For example it could be a government database, such as an Internal Revenue Service database, a state government tax database, a local government tax database, or a Securities Exchange Commission database. The coupling to the database 3 could be accomplished in any manner. For example, there could be a direct connection, with or without wires, between the form generation engine 1 and the database 3. Moreover, any sort of network access could provide the coupling. For example, there could be dial-up access, Internet access, X.25, or any other network access. Additionally, any protocol could be used for the coupling.

The interface between the form generation engine 1 and the database 3 is also preferably platform independent. In that case, the form generation engine 1 and the database 3 could each be part of independent computer systems. Specifically, the form generation engine 1 will communicate with the database 3 regardless of the structure or configuration of either one.

Information and data are preferably provided to the database 3 from various information sources 4-1, 4-2, . . . , 4-x. These information sources can be government sources or other sources, such as payors or payees that submit forms (such as forms W-2, 1099, 1098) to the IRS database. Any number of sources could provide information to the database at any point in time, and under any circumstances. Moreover, the data could be provided to the database in any form. Additionally, the data could come from any source or be calculated by the database or a processor coupled to the database or returned to the user or requesting forms processor. Thus, for example, the data could be taken from reports submitted to a government agency, such as the IRS. The reports could be submitted electronically or on paper. Alternatively, a private organization could request information for organizations, people, or other entities and compile a database based upon the requested information.

The coupling of the form generation engine 1 to the database over the communications link allows the information stored or processed in the database to be transferred to the form generation engine 1 for processing. The form generation preferable retrieves only information that is requested by a user, although it could retrieve all available data or prescribed portions thereof. Additionally, if the retrieved data is narrowed to the specific user presently requesting data, that data can be delivered in full, that is all data regarding a particular user could be delivered, or the data could be further filtered before delivery. That is, the request for data could inform the database 3 that only specific data is to be provided,

The form generation engine 1 could use the received data to generate any type of forms, for example, official government forms. These forms could be printed locally, or filed with an entity, such as a government agency, over a network. Additionally, the form generation engine 1 could compare the information from the database 3 with data provided by a user of the form generation engine 1. Such a user could be a taxpaying entity. Thus, by way of example, if the database 3 contains official IRS data, a taxpaying entity could request certain data from the database 3. This would preferably have been provided by individuals and organizations required to provide information to the IRS on behalf of the taxpaying entity. For example, an employer would provide information to the IRS regarding the wages paid to an employee.

After requesting this information from the database 3, the taxpaying entity could compare the “official” data from the database 3 to the taxpaying entity's own records. In this way, the taxpaying entity could verify the accuracy of these records. Alternatively, the taxpaying entity could obtain processed information from the database. That is, the owner of the database 3 could process “raw” data provided to the database 3 to make certain calculations. The calculations could then be stored in the database as the processed information or, preferably, would be returned to the requesting user. The taxpaying entity could then verify its own calculations to those stored in or received from the database 3 as processed information.

The data in the database 3 could be accessed by the form generation engine 1 in conjunction with any commercial form generating software or other commercial or custom software. For example, the form generation engine 1 could interface with a commercial tax software program. Such a combination would use the data from the database to prepare certain documents, such as, tax return documents. In such a configuration, it is preferable that the form generation engine 1 provide an interface between the commercial software and the database 3. This interface would allow the commercial software to collect only relevant information from the database 3. Additionally, it would allow commercial software from different vendors to be used. Alternatively, the form generation engine 1 could itself generate any prescribed form. In this way, no commercial software would be required.

FIG. 1b shows an embodiment of the system where the database is an official government database 3a. The official government database 3a could be a federal or state taxation information database, for example, or could be a securities information database, such as an SEC database. Furthermore, the database may also be a form repository, containing information about the forms to be generated. For example, it could contain layout information for any prescribed forms.

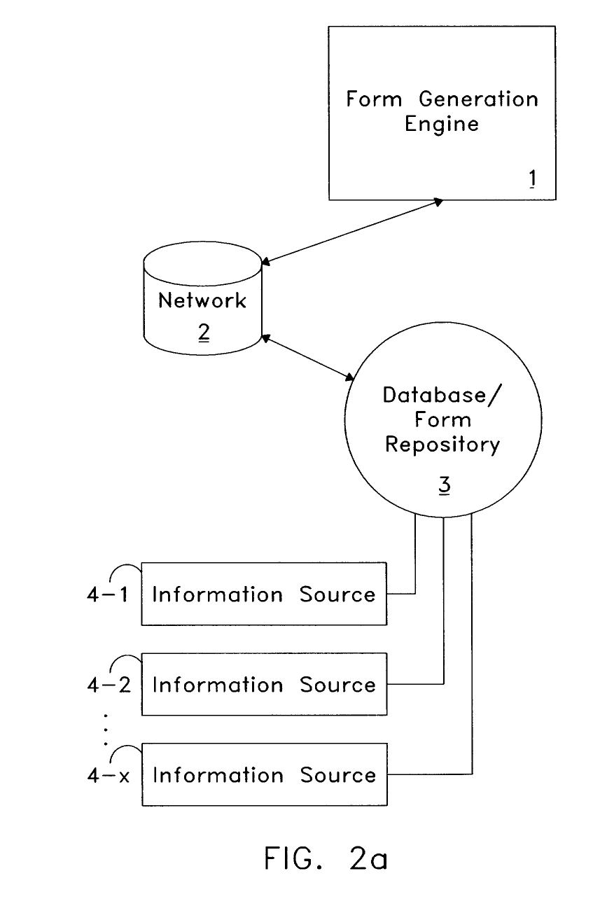

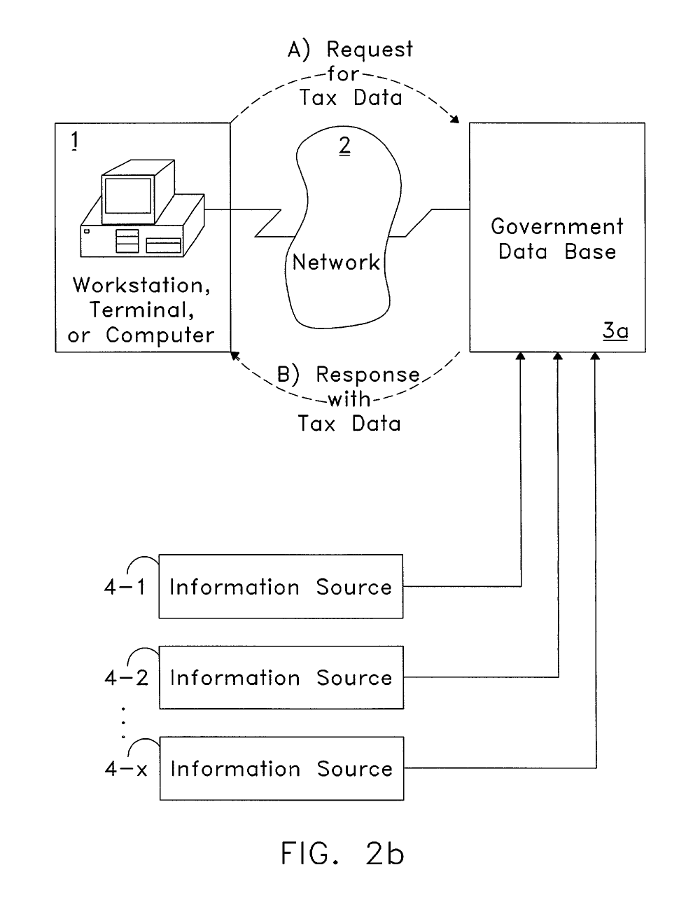

FIG. 2a shows an example of the form generation engine 1 coupled to the database 3 through a network 2. Any number of configurations could be used to couple the form generation engine 1 to the database 3. For example, the form generation engine 1 could dial in to the database 3 over a telephone network and access the database directly. Alternatively, the form generation engine 1 could couple to the database over a wide area network (WAN), a local area network (LAN), or the Internet. FIG. 2b shows an example where the form generation engine 1 is coupled through a network 2 to an official government database 3a.

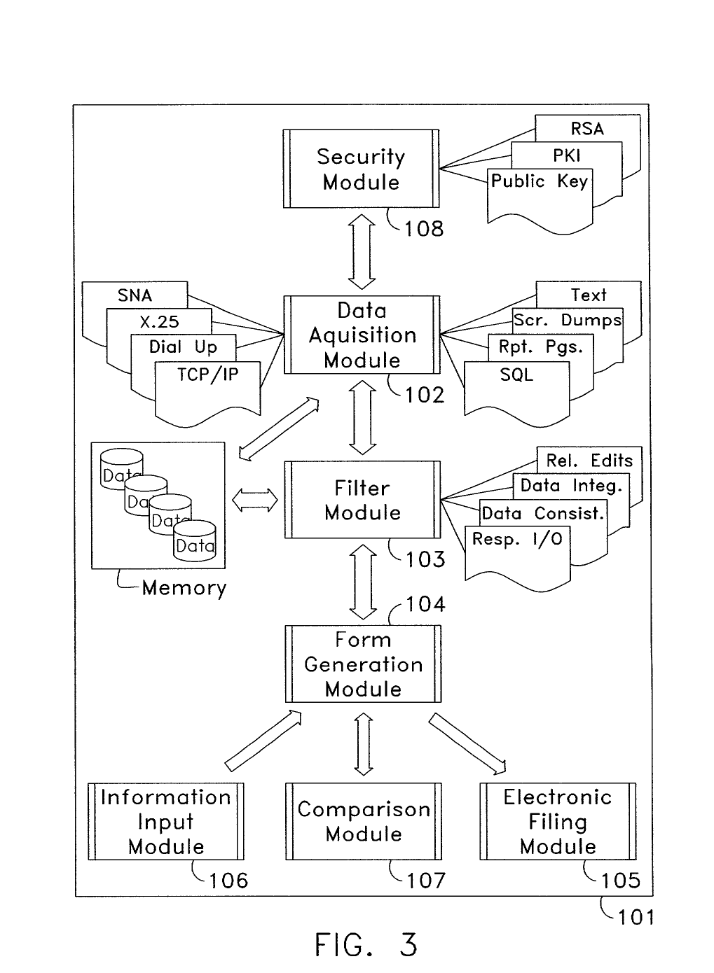

Referring to FIG. 3, the form generation engine 1 is preferably a software system 101, which can be broken down into multiple modules and/or sub-modules. Any combination of modules could be used to achieve the desired outcome. In a preferred embodiment, a data acquisition module 102 is provided to retrieve data from a remote location. For example, the data acquisition module could be a set of instructions which causes an input/output port of a local terminal to establish communication with a remote network, a remote computer, or a database. The instructions would preferably route the communications from the local computer to the database, even if several networking layers, routers, or other network nodes were between the two.

The data acquisition module would preferably contain all protocols necessary to communicate with the remote location. Any protocol could be used for this communication. For example, the protocol could be TCP/IP, X.25, SNA, or any other protocol used to communicatively couple the elements of the system. By establishing communication in this way, the data acquisition module could transfer instructions to the remote location, requesting that information be transferred back to the input/output port. The software system 101 thus acquires data. It should be noted that the data acquisition module 102 can be cross-platform according to one embodiment of the invention. That is, it can establish communication between the local computer and the remote location regardless of the operating system, structure, or command protocols of either system. In this way, the data acquisition module 102 can link any local computer to any other remote system.

Next, a filter module 103 is provided to filter the data acquired by the data acquisition module 102. For example, the filter module 103 could include a set of instructions with a user's preferences, such that only a prescribed portion of the acquired data is processed. The filter module 103 is preferably dynamically modifiable by a user, such that filter preferences can be changed from time-to-time. Thus, using the data acquired from the data acquisition module 102, a user can filter the data and derive prescribed segments of data multiple times, using multiple scenarios.

A form generation module 104 is provided to generate a report or form using the relevant data from the filter module 103. Such a report or form could be a tax return, for example. Alternatively, the form could be a print out of the information downloaded from the database. It should be understood that any form could be generated based on a user's preferences, and that the forms are modifiable. Examples of such forms are federal, state, and local tax return forms, as well as annual reports required to be filed by corporations.

Additionally, if the database 3 contains form information, that is, if the database 3 is serving as a form repository, the data acquisition module 102 could retrieve this information and pass it directly to the form generation module 104. The form generation module 104 would then generate an appropriate form. Additionally, the form generation module 104 could integrate other data from the database (i.e. user data) into the thusly generated form, so as to generate a completed form ready for filing.

When preparing a prescribed form, the filter module 103 could determine which data is required by the form generation module 104 for the form, and filter out all other information. The unused data would preferably be stored locally. Thus, the form generation module 104 would then be provided only with relevant data. The form generation module 104 preferably contains a set of instructions that configure the relevant data into a prescribed format. For example, the form generation module 104 could place certain portions of the relevant data at certain locations on a form to be generated. Additionally, if standard information is known to be required on a prescribed form, the form generation module 104 preferably provides this information without prompting the user. The form generation module 104 then preferably retrieves all of the relevant data to compile the form. If the form generation engine 1 (FIG. 1) is used in conjunction with commercial software, the commercial software could be relied upon to prepare the form. In such a case, the form generation module 104 would interface with the commercial software to cause the commercial soft-ware to prepare the appropriate forms using the relevant data.

Additionally, the form generation module 104 and the filter module 103 also make it possible for any commercial software to interface with the form generation engine 1. That is, the filter module 103 can provide only the information required by the commercial software. Thus, for example, if a user were accessing the IRS database to prepare tax returns, and if the user were using a commercial tax return preparation software, the filter module 103 of the form generation engine 1 would provide only the information required to prepare the tax return to the commercial tax return preparation software. By doing this, the operation of the system would be invisible to each user. The user runs the commercial software, and retrieves the relevant information from the IRS database. The commercial software preferably interfaces with the system through the form generation module 104.

An electronic filing module 105 is provided to submit formatted data, as well as standard or prescribed form data to a local input/output port for delivery to a remote location. Specifically, the electronic filing module 105 preferably contains a set of instructions that identify a particular form to be transferred, and establishes communication through an input/output port, for example, so as to send the prescribed form to the remote location. An example of this is to transmit tax return documents to the IRS as the official filing of a user's tax return. The protocol for such delivery could be any protocol prescribed by the receiving party. Moreover, the electronic filing module 105 would be platform independent. That is, the electronic filing model 105 could transmit information to any recipient, regardless of the recipient's system. For example, a user having a computer operating a first operating system could transmit data to the remote location having a computer or other system running a second operating system.

Next, an information input module 106 could optionally be provided to allow an entity to add additional information not provided by the remote location. For example, the entity could be an individual who is supplying additional data which is not supplied by the data acquisition module 102. The information input module 106 preferably includes an interface between the user and the software system.

Accordingly, the information input module 106 could cause an input screen on a monitor to prompt the user for particular information not provided from the database 3. In a preferred embodiment, the information input module would work in conjunction with a filter module to determine which data the user should input for a prescribed form. Alternatively, if the form generation engine 1 is operating in conjunction with commercial software, the information input module 106 could interface between the commercial software and the other components of the form generation engine 1. Thus, if the commercial software had a field that required additional information, the user could input information to that field, and the information input module 106 could capture that data. In some instances, however, it would be preferable to prevent or prohibit a user from modifying or augmenting the data received from the database 3. In such a case, the information input module 106 would be inactive.

Next, a comparison module 107 could optionally be provided to compare data inputted by a user with data acquired from the data acquisition module 102. For example, if a user desires to compare certain user provided information with information acquired by the data acquisition module 102, the comparison module 107 would cause the system to identify the pertinent fields to be compared. It would then compare the information provided through the information input module 106 with information provided by the data acquisition module 102. Preferably, the comparison module 107 could work in conjunction with the form generation module 104 to prepare a report indicating the accuracy of the data.

Alternatively, the comparison module 107 could be used with commercial software. Thus, if a user manually completed a form using the commercial software, the user could compare the completed form with data provided through the information input module 106. In this way, the user generated form could be checked for accuracy. For example, if a user were preparing a tax return document using commercial software and inputted data to that form manually, the user could then verify the accuracy of the user generated form by comparing the data with data received from the IRS database or other database having similar information.

Moreover, the information input module 106 could work in conjunction with the filter module 103, so that a user could input all data available, and then allow the filter module to select prescribed segments of the data for a particular use. Additionally, the form generation module 104 and the electronic filing module 105 could work with the information input module 106 to prepare forms without needing the data acquisition module 102. This would allow a user to prepare forms and electronically file them without having to access a remote database or remote location. Accordingly, if the user had previously retrieved information from the database 3 or otherwise, the user could generate and file forms at a later time. Alternatively, if the user did not wish to download any information, the user could still use this system to file forms electronically. Because the system could be tailored to any particular use, this single system could be used for any number of forms. For example, the user could file tax forms with federal, state, and local entities, as well as to file corporate reports with federal and state authorities.

Finally, security module 108 is provided to negotiate any security protocols or security systems established by the remote locations.

FIG. 4 illustrates the form generation engine 501 alternatively provided as an apparatus for retrieving and processing data to generate forms or compare data. As shown in FIG. 4, the form generation engine 501 includes an input/output unit 545. The input/output unit 545 preferably couples with the network 2 or the remote database 3. Additionally, the input/output unit 545 is configured to locally receive information from a user. For example, a user could key in information to be used by the form generation engine 1 such as his taxpayer information. The input/output unit 545 comprises an information input unit 535, to receive incoming data, and electronic filing unit 540, to output completed forms in electronic format.

Next, a security unit 510 is provided. The security unit 510 preferably couples to the input/output unit 545 to allow the input/output unit 545 to establish secure communications with the remote database 3, the network 2 FIG. 2), or any other device with which it needs to communicate. The security unit 510 could include a public key, PKI, or RSA, which is a secure method of authenticating a user and securing a communications channel.

A data acquisition unit 520 is also provided. The data acquisition unit 520 is coupled to the input/output unit 545, and is the primary interface between the form generation engine 1 and the network 2/database 3. The data acquisition unit 520 includes the necessary protocols to communicate with remote devices. For example, the data acquisition unit 520 includes TCP/IP, SNA, dial-up protocols, and X.25. Additionally, the data acquisition unit 520 can acquire data in any form. For example, formats such as text, screen dumps, report pages, and SQL are acceptable. The data acquisition unit 520 thus serves to make the form generation engine 1 platform independent. That is, it functions with any operating system, and can achieve communications with a remote system having any operating system and using all protocols. The data acquisition unit 520 is further coupled to the security unit 510. In this way, the data acquisition unit 520 can directly access secure information from a remote location.

A filter 530 is coupled to the data acquisition unit 520 and the input/output unit 545. The filter 530 processes the data acquired by the data acquisition unit 520. The filter 530 prevents irrelevant or unwanted data from being passed on to other components. The filter 530 is preferably instructed by the user, either through input commands or prescribed requirements selected in advance, as to what data to filter out. For example, if the user for preparing a given tax form, the user could input the desired form number to the filter. The filter would then determine what data is required for that form, and filter out any other information.

Next, a form generation unit 515 is provided. The form generation unit 515 is coupled to the data acquisition unit 520. Additionally, the form generation unit 515 is coupled to the filter 530. The form generation unit 515 receives either unfiltered data directly from the data acquisition unit 520, or filtered data from the filter 530. The form generation unit 515 processes the received data and formats it according to prescribed criteria. The prescribed criteria is preferably supplied by the user. The criteria, however, could be received from a remote location including the remote database 3 or a data arbiter. By processing the data, the form generation unit 515 preferably configures the received data as a prescribed form. For example, if the user were preparing a federal tax return, the form generation unit 515 would receive the relevant data from the filter 530, perform any calculations necessary to the data, and prepare the federal tax return form using both the received data and the results of the calculations.

The form generation unit 515 preferably outputs the thusly generated forms to the input/output unit 545. From there, the form can either be filed electronically with a third party, or printed locally. It should be noted that the third party need not be the taxing authority. Rather, a user could forward draft documents to another party for review purposes or otherwise. For example, a user may wish to forward a completed tax return to his accountant for review before filing it with the taxing authority.

Finally, a memory 525 and a comparator 505 are provided. The memory 525 optionally stores data directly from the data acquisition unit 520 or from the filter 530. Moreover, the memory 525 can provide raw data to the filter 530, which will ultimately be used by the form generation unit 515. The filter 530 processes the data as described above, and can provide the filtered data to the form generation unit 515, the input/output unit 545, the comparator 505, or back to the memory 525.

Additionally, the memory 525 is coupled to the form generation unit 515. Through this coupling, the memory 525 can store an output of the form generation unit 515, or can provide stored data directly to the form generation unit 515. Such data could include user data, for example tax data received from a tax database, or form definition data, for example form layout information needed to prepare an actual form.

The comparator 505 is coupled to the form generation unit 515, the memory 525, the data acquisition unit 520, and the filter 530. The comparator 505 preferably processes information provided by the user and information provided by a remote location to compare it and determine discrepancies between the two sets of data. For example, if the user wanted to determine the accuracy of certain records which were kept by both the user and a third party, the user could input his data and acquire the third party's data through the input/output unit 545 and the data acquisition unit 520. If the third party's data were more extensive than the user's data, the filter 530 could forward to the comparator 505 only that data which was relevant to the comparison. The comparator 505 would then preferably process both sets of data, and provide its analysis to either the form generation unit 515 or the input/output in 545. The form generation unit 515 could format the results of the comparison and generate a report. Alternatively, if the analysis were provided directly to the input/output unit 545, the data could be directly outputted for formatting elsewhere.

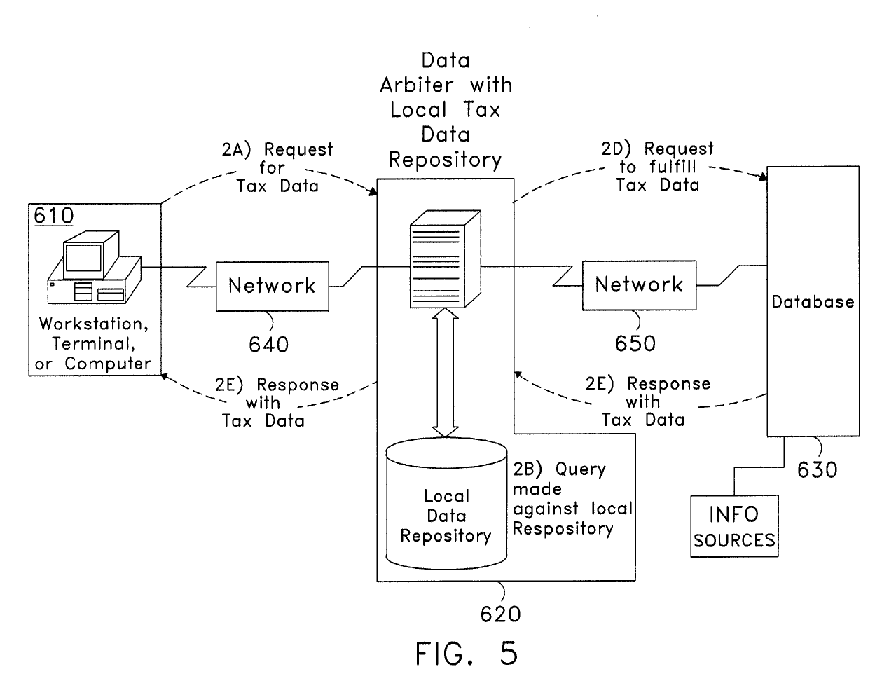

FIG. 5 shows the configuration of the system including a data arbiter 620 on a network. The data arbiter serves as an intermediary between the user's terminal 610 and the remote database 630. The data arbiter 620 could be the form generation engine configured as software, as described with respect to FIG. 1a, or configured as hardware, as described with reference to FIG. 4. Alternatively, the arbiter need not have a form generation engine included, and could be coupled between the form generation engine and the database. Thus, the terminal 610 may include a form generation engine (not shown). The data arbiter 620 preferably includes the form generation engine 501, as described in FIG. 4. For example, the data arbiter includes an input/output unit 545 for coupling to the user's terminal and the remote database. These couplings would preferably be achieved over networks 640, 650. In such a situation, the user's terminal would not require the form generation engine 501 (FIG. 4) to be part of the terminal. Rather, the user would send a request to the data arbiter to provide either a completed form, a comparison, or raw data. The data arbiter, in turn, would establish a communication link with the remote database and gather the required information. This information could optionally be stored in memory 525 (FIG. 4), and processed according to the user's request. Upon the completion of processing, the data arbiter could output the requested form to the user, or could complete electronic filing for user. The terminal 610 and the database 630 are preferably coupled to the data arbiter 620 over a network 640 and 650, respectively. As previously described, the network could be any type of network. Additionally, network 640 is not necessarily the same as network 650. For example, network 640 could be the Internet, while network 650 could be a local area network.

In this configuration, the functions of the form generation engine 1 are carried out remotely on the data arbiter 620. The user would thus submit requests through an output port of his terminal and the data arbiter 620 would perform all of the functions of the form generation engine. Multiple users could access the data arbiter 620 simultaneously and have various tasks completed. The user would still need to authenticate the user's identity, but in this case, it would preferably be authenticated by the data arbiter 620.

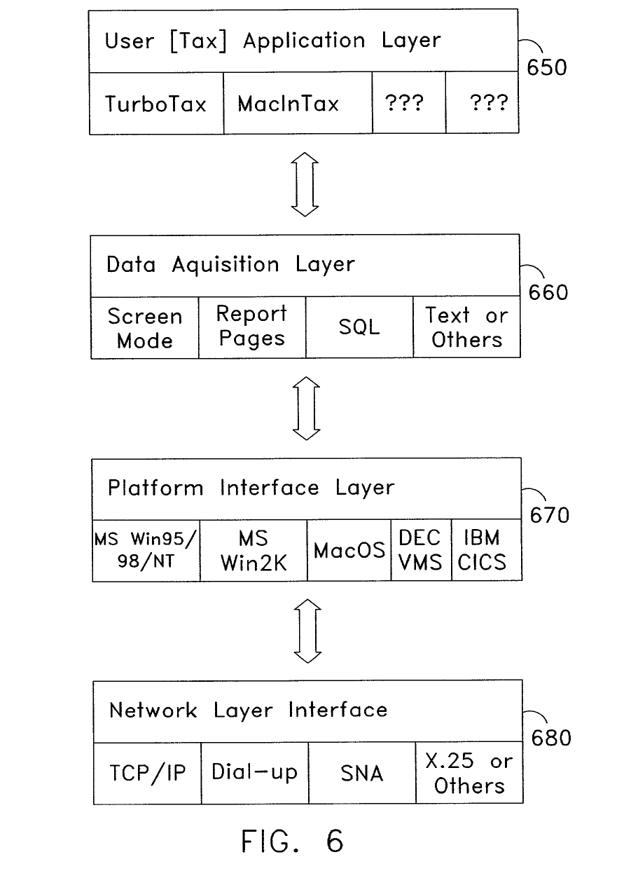

FIG. 6 shows layers of modular components of the system, according to a preferred embodiment. First, the top layer is a user application layer 650. This layer is preferably the front end of the system which the user sees on a terminal screen. It could either be a commercial software interface, such as Turbo Tax, or any other program requiring data entry, or a custom front end. The custom front end could be designed either by the user, using prompts provided by the system, or could be supplied by an owner of a database to be accessed.

The next layer is a data acquisition layer 660. This layer preferably determines how data will be acquired. For example, it could be SQL, report pages, screen mode, or others. It also receives the retrieved data.

The next layer is a platform interface layer 670. This layer allows the system to be platform independent with respect to system configuration and operating systems. Specifically, it enables the system to be installed and operated in accordance with any operating system, and likewise to interface with a remote location having any operating system. Examples of such operating systems include UNIX, LINUX, DEC VMS, DOS, Mac OS, or any of the Microsoft Windows family operating systems, for example.

The next layer is a network interface layer 680. This allows the local system to access the remote system either directly or over a network. For example, the network interface layer could be TCP/IP, SNA, X.25, or a dial-up connection. It should be noted that any protocol could be used with this system. Additionally, the system could be set up as a LAN or a WAN.

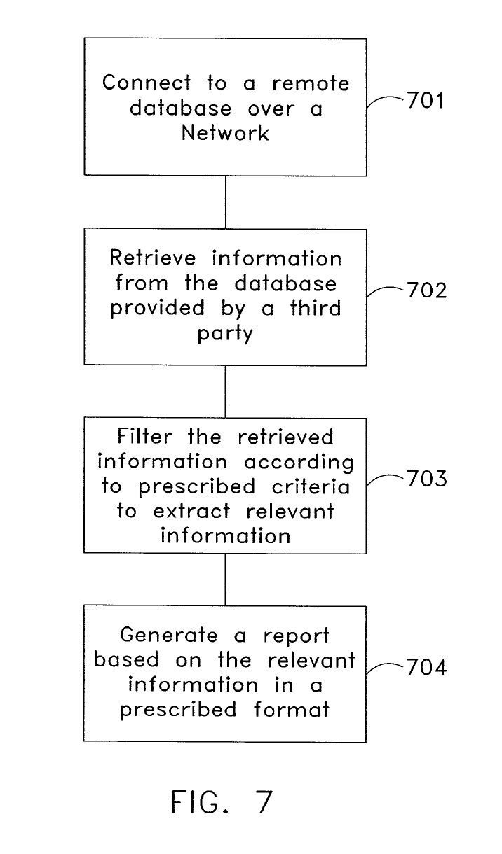

Referring to FIG. 7, a method for acquiring and formatting data according to a preferred embodiment will now be described. First, a user connects to a remote database, as shown in Step 701. This is preferably done over a network. The network could be a local area network, a wide area network, or the Internet. Alternatively, a direct connection could be established. Additionally, the remote database is preferably an official government database that requires access privileges to connect. The security and access rights would also be negotiated between the user and the remote database.

Next, as shown in Step 702, information is retrieved from the database. This information is preferably provided by a third party or third parties. Examples of such information include wages paid, interest earned, and withholdings.

Next, as shown in step 703, the retrieved information is filtered according to a prescribed set of rules to extract relevant information. The relevant information could be prescribed by a user, or could be generated by the system according to the user's needs. For example, if the user desires to prepare a certain document, such as a tax return document, the system could identify what information is required for that document. In this way, the user does not need to identify the particular information needed, but must merely identify the form to be generated. Additionally, while standard forms could be predefined in the system, the user could define additional forms. By doing this, the user would need to identify the relevant information only once, and then access the information using the form definition.

Next, as shown in step 704, a report is generated based on the relevant information and presented in a format that is preferably prescribed by the third party. For example, the user wishes to file a federal tax return, the report would be based upon a form as prescribed by the IRS, such as form 1040. Alternatively, the format could be any format. Specifically, the format could be driven by the filtering function, so that a particular set of information could be provided for a particular format. Also, the report could be formatted for electronic filing.

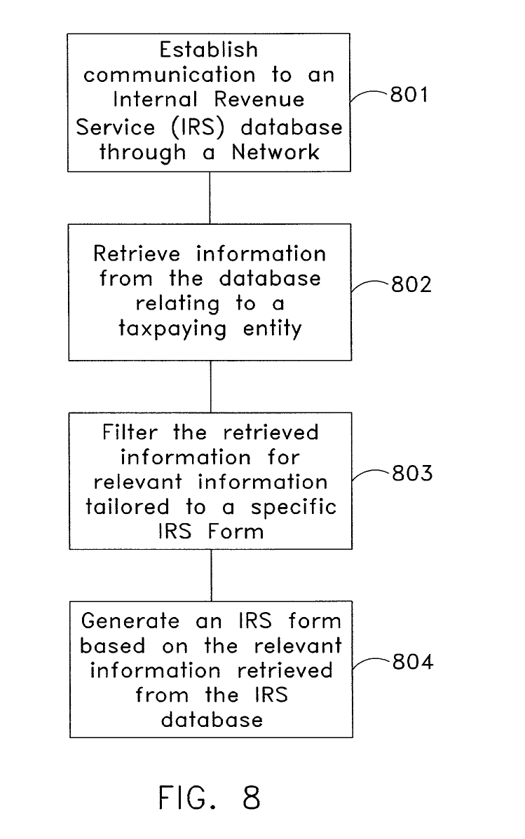

An example of an application of this system according to one embodiment of the invention is illustrated in FIG. 8. Referring to FIG. 8, a method for retrieving tax data from the IRS and generating IRS forms and state forms is described. The process includes establishing communication with an IRS database, as shown in step 801. This could be done by a direct connection, or through a network. The network could be any type of network, including a LAN, a WAN, or the Internet. The security and access rights would also be negotiated between the user and remote database.

Next, as shown in Step 802, information relating to a taxpaying entity is retrieved from the IRS database. Such information would preferably be tax information, such as wages earned, taxes paid, and interest earned, for example. Additionally, because this is a government database, certain authentication procedures are contemplated before data will be accessible. Thus, the user desiring access would have to provide security information to the database. In a preferred embodiment, this information would be provided automatically after being inputted once by the user.

The information retrieved is then filtered for relevant information tailored to a specific tax form, for example federal or state tax returns, as shown in Step 803. Thus, if a user wished to have a tax return prepared for the taxpaying entity, only information relevant to preparation of the tax return would come through the filter. In a preferred embodiment, the filter could be dynamically changed so that a user could generate multiple forms from the retrieved data.

Next, as shown in step 804, a tax form corresponding to the relevant information is generated. Preferably, the filtered data would be presented in a format which would match the prescribed form. The entire form could be generated by the system in a prescribed format including the relevant data. The form could then be extracted from the system, for example, by printing or electronic filing.

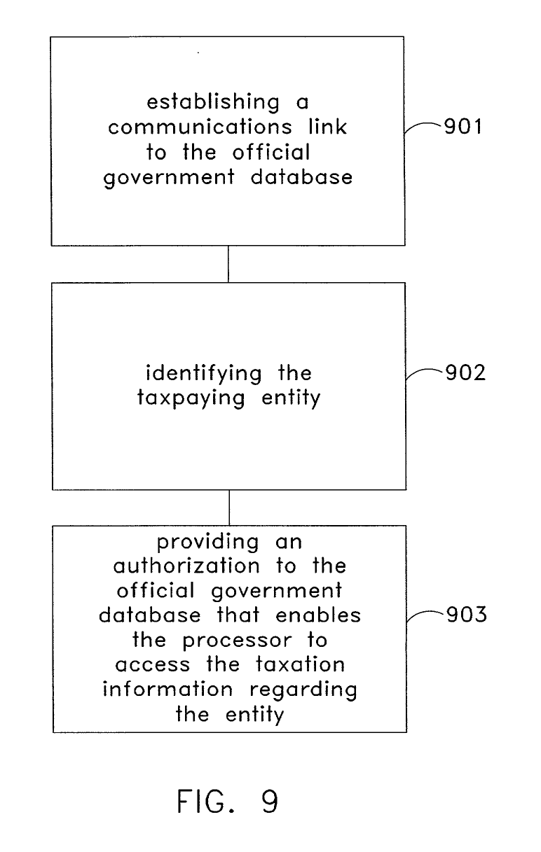

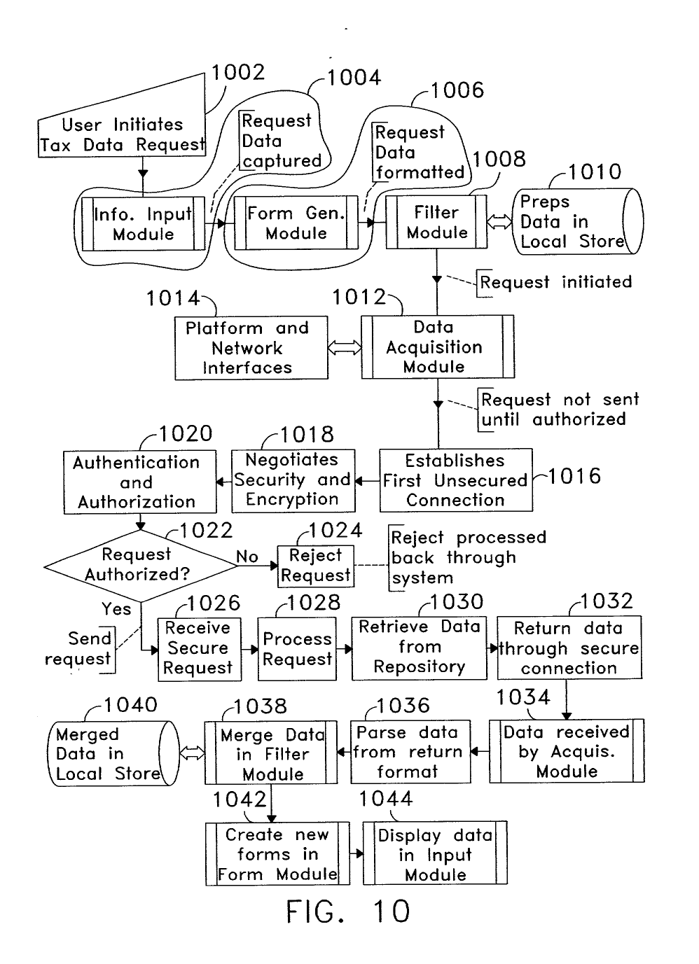

Referring next to FIG. 9, a method of establishing communications with the remote database is illustrated. The remote database is preferably an official government database. The method first requires establishing a communication link to the official government database, as shown in step 901. This is preferably done by using the appropriate data transfer protocols required by the official government database. A communication link could be over a telephone line, or over a network. In a preferred embodiment, the system is completely platform independent. That is, any two operating systems could communicate with each other by using appropriate protocols. Additionally, any method of connection is supported. For example, any protocol could be used, such as TCP/IP or any packet switching protocol.

Once the communication is established, the taxpaying entity for which information is requested must be identified, as shown in step 902. This could be done, for example, using an identification number, such as a Federal ID or a Social Security number, a name, or some other taxpaying entity identifier.

Once the entity is identified, if proper authorization is required, it will be provided, as shown in Step 903. Thus, for example, the user would provide appropriate authentication to the official government database that enables the user to access official information regarding the entity. Authorization to access taxation information at the IRS would preferably be required before any data could be retrieved from the database.

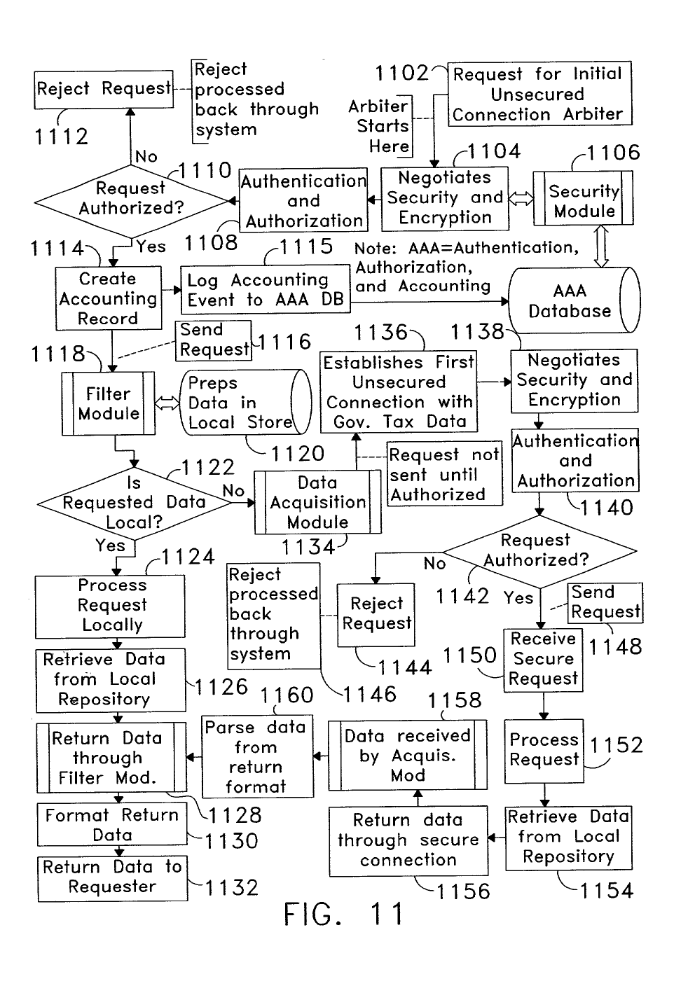

FIG. 10 shows a data request process according to a second embodiment. Initially, a user locally initiates a tax data request, as shown in Step 1002. The request is processed through an information input module, as shown in Step 1004. The request can then optionally be formatted by the form generation module and the filter module, as shown in Steps 1006 and 1008. Additionally, any data that is stored locally can be accessed and prepared in accordance with the formatted data request, as shown in Step 1010.

The request is then initiated and sent to the data acquisition module, as shown in Step 1012. To insure that the method is platform independent, the request is optionally processed by platform and network interfaces, as shown in Step 1014. During this step, any protocol processing or formatting is accomplished to allow the request to be communicated to and understood by a remote database. The thusly generated request is sent, and establishes a first unsecured connection with the remote location, as shown in Step 1016. The request is preferably sent through a communications network to a tax database. If any security or encryption procedures are present, they are negotiated in Step 1018. Then, as shown in Step 1020, authorization and authentication processes take place. In this way, it can be verified that the user is entitled to have access to the remote location. The system preferably responds to the remote database's challenge or prompts the user to respond. It is preferably next determined if the request is authorized, as shown in Step 1022. If the request is not authorized, it can be rejected, as shown in Step 1024.

If the request is authorized, it is sent forward and received by the remote location, as shown in Step 1026. The request is preferably then processed in Step 1028, and data is retrieved from the repository, as shown in Step 1030. The retrieved data is preferably returned to the user through the secure connection, as shown in Step 1032, and it is received by the data acquisition module, as shown in Step 1034.

The data, as received, is then parsed from the received format, as shown in Step 1036. The parsed data is then received by the filter module, as shown in Step 1038. The processed data can optionally be stored locally, as shown in Step 1040, and desired forms are created in association with the form generation module, as shown in Step 1042. The data can then be displayed in a user prescribed format using the input module, as shown in Step 1044. The display can be a printed form.

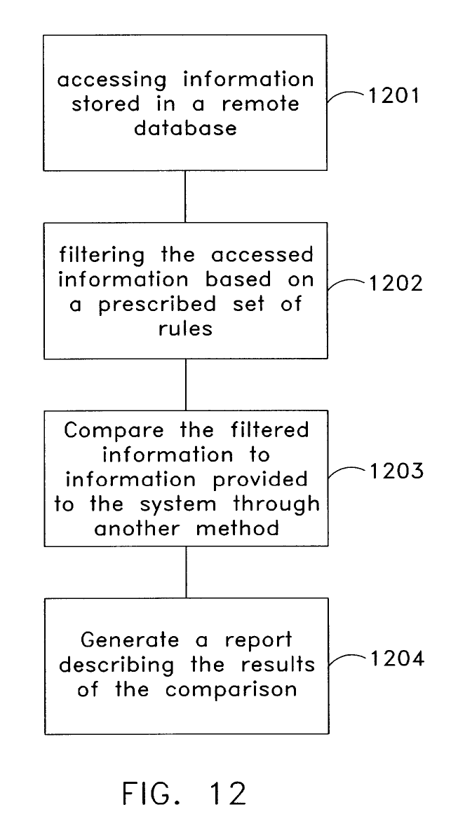

FIG. 11 is a flowchart illustrating a data request process through a data arbiter. Initially, a request for an unsecured connection is made, as shown in Step 1102. This request is generated locally by a user or a user's terminal, and is preferably sent to a remote database over a communications network. It should be understood that all necessary protocols will be used to achieve communication with the remote database.

The remote database may additionally have security protocols in place. The request thus negotiates security and encryption layers, as shown in Step 1104. Then, as shown in Step 1108, authentication and authorization is performed. This is preferably done by the user's terminal sending authentication information, such as name, password, or authentication code, for example, directly to the remote location. Next, based on the authentication it is determined if the request is authorized, as shown in Step 1110. If the request is not authorized, it is preferably rejected, as shown in Step 1112.

If the request is authorized, an accounting record is created, as shown in Step 1114. This event is preferably logged into an authentication, authorization, and accounting database as in Step 1115. The request is then optionally sent to the filter module, as shown in Step 1118. The filtered data request can be stored locally, as shown in Step 1120.

It is then determined whether the requested data is local, as shown in Step 1122. If the request is local, it is processed locally, as shown in Step 1124, and the data is retrieved from a local repository, as shown in Step 1126. The thusly retrieved data is returned through the filter module, as shown in Step 1128. The data is then formatted, as shown in Step 1130, and provided to the user, as shown in Step 1132.

If it is determined in Step 1122 that the requested data is not local, the request is sent to the data acquisition module, as shown in Step 1134. Upon authorization, a first unsecured connection with the remote database is established, as shown in Step 1136. This connection could be with an official government tax database, for example. Security and encryption protocols are then negotiated, as shown in Step 1138, and the system awaits authentication and authorization, as shown in Step 1140. If the request is not authorized, the system is informed that the request has been rejected, as shown in Step 1144. Such authorization is similar to that described above.

If the request is determined to be authorized, the request is sent to and received by the remote database, as shown in Step 1150. The request is processed, data is retrieved from the repository, and preferably returned through a secure connection, as shown in Steps 1152, 1154, and 1156. The data is then received by the data acquisition module, as shown in Step 1158. That data is then parsed from the received format, as shown in Step 1160. The parsed data is then received by the filter module, as shown in Step 1128, and formatted and returned to the user, as shown in Steps 1130 and 1132.

Referring next to FIG. 12, after information is downloaded from the database, the system could perform a comparison function instead of generating a form. Specifically, as shown in step 1201, the taxation information regarding an entity is accessed from the official government database. It should be understood that the information is not limited to taxation information.

As shown in step 1202, the accessed information is filtered based on a prescribed set of rules. In Step 1203, the filtered information is compared to information inputted by the user, to verify the accuracy of either set of numbers. Specifically, the system compares particular data items retrieved from the database with corresponding items provided by the user. A report is preferably generated for the user which would indicate which items matched and which items did not match, as shown in Step 1204. This could assist the user in identifying discrepancies between the user's information and the government's information.

The system and method as described herein has many advantages. For example, a user is able to access a remote database to download information provided by third parties. Additionally, the database can be an official government database, such as an IRS database having taxpayer information. Thus, much time and effort are saved by the user accessing this data. Also, forms required to be filed by certain entities can be automatically prepared using the downloaded information. Moreover, a user can automatically compare user inputted data with the official downloaded data. In these ways, time is saved and errors are avoided.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A method of generating a completed governmental taxation authority tax form for a taxpaying entity, comprising:
establishing a communications link between an input/output device to a tax database having taxpaying entity information;
downloading the taxpaying entity information from the database to the input/output device;
filtering the taxpaying entity information to yield form generation information; and
generating at least one tax form using the form generation information.

2. The method of claim 1, further comprising filing the generated form electronically with the governmental taxation authority from the terminal.

3. The method of claim 1, wherein the taxpaying entity information in the database is official financial information supplied to the database by at least one third party.

4. The method of claim 1, wherein the database is one of an Internal Revenue Service database, a state government tax database, and a local government tax database.

5. The method of claim 1, wherein the communications link established between the input/output device and the database is established on one of a computer network and a communications network.

6. The method of claim 5, wherein the computer network is one of a local area network, a wide area network, and the Internet, and the communications network is one of an optical, wireless, or wire network.

7. The method of claim 1, wherein the input/output device comprises one of a personal computer, a terminal, a workstation, and a PDA.

8. The method of claim 1, wherein the step of establishing a communications link comprises providing access information to the database to access confidential information.

9. The method of claim 1, wherein the taxpaying entity information downloaded from the database comprises income tax return information, and wherein the step of generating the desired tax form comprises generating an income tax return form.

10. The method of claim 9, further comprising comparing the taxpaying entity information downloaded from the database to independent information provided by another source to determine if any differences exist between the taxpaying entity information and the independent information.

11. The method of claim 10, wherein the independent information comprises information provided by the taxpaying entity.

12. The method of claim 1, wherein the step of connecting a terminal to the tax database comprises supplying information to the tax database to identify the entity, and supplying an authorization to access information in the database relating to the entity.

13. A form generation engine, comprising:
an input/output device, configured to send/receive taxpaying entity information to/from tax database over a communications network regarding at least one taxpaying entity; and
a processor, configured to filter data received from the database to extract prescribed information, and to generate a prescribed tax form using the prescribed information.

14. The form generation engine of claim 13, wherein the input/output device receives the generated tax form from the processor and outputs the generated form.

15. The form generation engine of claim 13, wherein the database comprises at least one of an Internal Revenue Service database and a state government tax service database.

16. The form generation engine of claim 13, wherein the input/output device is selected from among a personal computer, a terminal, a workstation, and a PDA.

17. The form generation engine of claim 13, wherein the input/output device is configured to couple to at least one of one of a local area network, a wide area network, and the Internet.

18. The form generation engine of claim 13, further comprising a memory circuit to store information received from the database.

19. The form generation engine of claim 13, wherein the generated form is outputted to one of a local printer and over a communications network to an entity requiring the form.

20. A computer readable medium having stored thereon a sequence of instructions which, when executed by a processor, cause the processor to perform a sequence of steps, comprising:
accessing taxpaying entity information that is stored in a tax information database;
filtering the taxpaying entity information based on prescribed criteria to generate filtered information; and
generating a government tax form using the filtered information.

21. The computer readable medium of claim 20, wherein the sequence of instructions causes the processor to perform the further step of comparing the taxpaying entity information to independent information supplied by the taxpaying entity to determine if there is a discrepancy between the taxpaying entity information and the independent information.

22. The computer readable medium of claim 20, wherein the sequence of instructions causes the processor to file the government tax form electronically over a communications network.

23. The computer readable medium of claim 20, wherein the step of accessing taxation information comprises:
establishing a communications link to the tax information database;
identifying the taxpaying entity; and
providing an authorization to the tax information database that enables the processor to access the taxation information regarding the taxpaying entity.

24. The computer readable medium of claim 20, wherein the step of generating the government tax form comprises generating a tax return for the entity.

25. The computer readable medium of claim 20, wherein the tax information database is an official federal, state, or local government database.

26. The computer readable medium of claim 20, wherein the step of accessing taxation information comprises coupling the processor to the database and establishing two-way communication with the database using prescribed protocols.

27. A method of generating a tax return for a taxpaying entity, comprising:
downloading taxpaying entity information from an official Internal Revenue Service (IRS) database;
calculating tax return information using the taxpaying entity information;
receiving independent taxation information provided by the taxpaying entity;
comparing the taxpaying entity information downloaded from the IRS database with the independent taxation information provided by the entity; and
generating a tax return form using the taxpaying entity information downloaded from the IRS database, the independent taxation information provided by the taxpaying entity, and the results of the comparison step.

28. The method of claim 27, further comprising filing the final tax return electronically with the IRS.

29. A method of generating a completed form for an entity, comprising:
establishing a communications link between an input/output device to a government database having official entity information;
downloading the official entity information from the database to the input/output device;
filtering the official entity information to yield form generation information; and
generating at least one prescribed form using the form generation information.

30. The method of claim 29, wherein the input/output device is selected from among a personal computer, a terminal, a workstation, and a PDA.

31. The method of claim 29, wherein the input/output device is an arbiter between a plurality of entities and the database.

32. The method of claim 29, wherein the government database is one of an Internal Revenue Service database, a state government tax database, a local government tax database, and a Securities Exchange Commission database.

33. The method of claim 1, wherein the input/output device is an arbiter between a plurality of taxpayers and the database.
